(19) United States
(12) Patent Application Publication
(10) Pub. No.: US 2023/0291879 A1
(43) Pub. Date: Sep. 14, 2023

(54) CALIBRATION OF WAVEGUIDE HEAD-UP DISPLAY

(71) Applicant: GM Global Technology Operations LLC, Detroit, MI (US)

(72) Inventors: Kai-Han Chang, Madison Heights, MI (US); Thomas A. Seder, Fraser, MI (US); Joseph F. Szczerba, Grand Blanc, MI (US); John P. Weiss, Shelby Township, MI (US)

(21) Appl. No.: 17/691,506

(22) Filed: Mar. 10, 2022

(51) Int. Cl. H04N 9/31; G02B 27/01

(52) U.S. Cl. CPC H04N 9/3194; G02B 27/0103; H04N 9/3152

(57) ABSTRACT

A head-up display system includes a hologram projector adapted to project a holographic image, a spatial light modulator, an exit pupil replicator, a diffuser adapted to be positioned within a x-y plane at a center point of a vehicle eyellipse, the hologram projector adapted to project a dot pattern onto the diffuser, and a controller adapted to compare the location of the projected dot pattern to the center point of the vehicle eyellipse to identify misalignment of the projected dot pattern relative to the center point of the vehicle eyellipse.

### INTRODUCTION

The present disclosure relates to a head-up display and more particularly to a system and method for calibrating a waveguide-based holographic head-up display.

A head-up display (HUD) has become common in modern automobiles. HUDs project useful information like speed and navigation information into the driver's field of view. This avoids forcing the driver to look down, away from the road, to read gages on the dash of the automobile. This reduces driver distractions and keeps the driver's eyes on the road.

New HUD systems may include projecting augmented reality images, such as optimal travel paths or navigation arrows to provide images that appear to be on the actual road surface. Unfortunately, HUD systems with such capability are set up to provide accurate placement for the “nominal driver”. To ensure that a driver sees such projected images at the proper location on the road surface, the position of the projected image must be adjusted to accommodate for varying heights of the vehicle and varying vertical location of the driver's eyes relative to the HUD system.

Traditional methods of calibrating a HUD system include placing a camera at the center of the vehicle eyellipse with a robotic arm and holding the camera in place. A test image is projected and bore-sighted with a scaled target. The bore-sighting process is performed at three different heights, high, nominal and low.

Thus, while current HUD systems and methods achieve their intended purpose, there is a need for a new and improved method of calibrating a HUD system to ensure proper perceived location of virtual images on a road by the driver.

### SUMMARY

According to several aspects of the present disclosure, a method of calibrating a head up display system for an automobile includes placing a diffuser that is aligned with an x-y plane at a center point of a vehicle eyellipse, projecting, with the head up display system, a dot pattern onto the diffuser, and comparing the location of the projected dot pattern to the center point of the vehicle eyellipse to identify misalignment of the projected dot pattern relative to the center point of the vehicle eyellipse.

According to another aspect, the diffuser includes at least one fiducial pattern that is aligned with the center point of the vehicle eyellipse.

According to another aspect, the method further includes using a camera to align the at least one fiducial pattern with the center point of the vehicle eyellipse when placing the diffuser.

According to another aspect, the method further includes using the camera to compare the location of the projected dot pattern to the at least one fiducial pattern to identify misalignment of the projected dot pattern relative to the center point of the vehicle eyellipse.

According to another aspect, the camera is a camera of a driver monitoring system.

According to another aspect, the method further includes identifying horizontal misalignment along a y-axis and identifying vertical misalignment along a z-axis.

According to another aspect, the method further includes adjusting the projected dot pattern to align the projected dot pattern with the at least one fiducial pattern and the vehicle eyellipse.

According to another aspect, the adjusting the projected dot pattern further includes fine-tuning a laser incident angle from a spatial light modulator to a pupil expander of the head up display system to align the projected dot pattern with the at least one fiducial pattern and the vehicle eyellipse.

According to another aspect, the head up system further includes a controller in communication with the camera and adapted to control the spatial light modulator and pupil expander, and the adjustment of the projected dot pattern is done automatically once misalignment of the projected dot pattern is identified with the camera.

According to another aspect, the adjustment of the projected dot pattern is done manually once misalignment of the projected dot pattern is identified visually.

According to another aspect, the method further includes creating a model of adjustment parameters for different eyellipse positions.

According to several aspects of the present disclosure, a head-up display system includes a hologram projector adapted to project a holographic image, a spatial light modulator, an exit pupil replicator, a diffuser adapted to be positioned within a x-y plane at a center point of a vehicle eyellipse, the hologram projector adapted to project a dot pattern onto the diffuser, and a controller adapted to compare the location of the projected dot pattern to the center point of the vehicle eyellipse to identify misalignment of the projected dot pattern relative to the center point of the vehicle eyellipse.

According to another aspect, the diffuser includes at least one fiducial pattern that is aligned with the center point of the vehicle eyellipse.

According to another aspect, the system further includes a camera in communication with the controller and adapted to identify a position of the at least one fiducial pattern relative to the center point of the vehicle eyellipse to allow the system to align the at least one fiducial pattern with the center point of the vehicle eyellipse when positioning the diffuser.

According to another aspect, the camera is further adapted to identify a position of the projected dot pattern relative to the at least one fiducial pattern to allow the controller to compare the location of the projected dot pattern to the center point of the vehicle eyellipse and identify misalignment of the projected dot pattern relative to the center point of the vehicle eyellipse.

According to another aspect, the controller is adapted to compare the location of the projected dot pattern to the center point of the vehicle eyellipse to identify horizontal misalignment along a y-axis and vertical misalignment along a z-axis.

According to another aspect, the controller is further adapted to adjust the projected dot pattern to align the projected dot pattern with the at least one fiducial pattern and the vehicle eyellipse.

According to another aspect, the controller is adapted to fine-tune a laser incident angle from the spatial light modulator to the pupil expander of the head up display system to align the projected dot pattern with the at least one fiducial pattern and the vehicle eyellipse.

According to another aspect, the controller is adapted to one of automatically adjust the projected dot pattern once misalignment of the projected dot pattern is identified with the camera, and allow manual adjustment of the projected dot pattern once misalignment of the projected dot pattern is identified visually.

According to another aspect, the controller is adapted to compile a model of adjustment parameters for different eyellipse positions.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a head-up display system according to an exemplary embodiment;

FIG. 2 is a graphical illustration of an eyebox and a vehicle eyellipse, wherein the eyebox is aligned with a center point of the vehicle eyellipse;

FIG. 3 is a graphical illustration of an eyebox and a vehicle eyellipse, wherein the eyebox is misaligned from the center point of the vehicle eyellipse;

FIG. 4 is a graphical illustration of an eyebox and an array of projected dots projected onto a diffuser, wherein the eyebox and the array or projected dots are misaligned from the center point of the vehicle eyellipse; and

FIG. 5 is a flow chart representing a method according to an exemplary embodiment of the present disclosure.

### DETAILED DESCRIPTION

The following description is merely exemplary in nature and is not intended to limit the present disclosure, application, or uses.

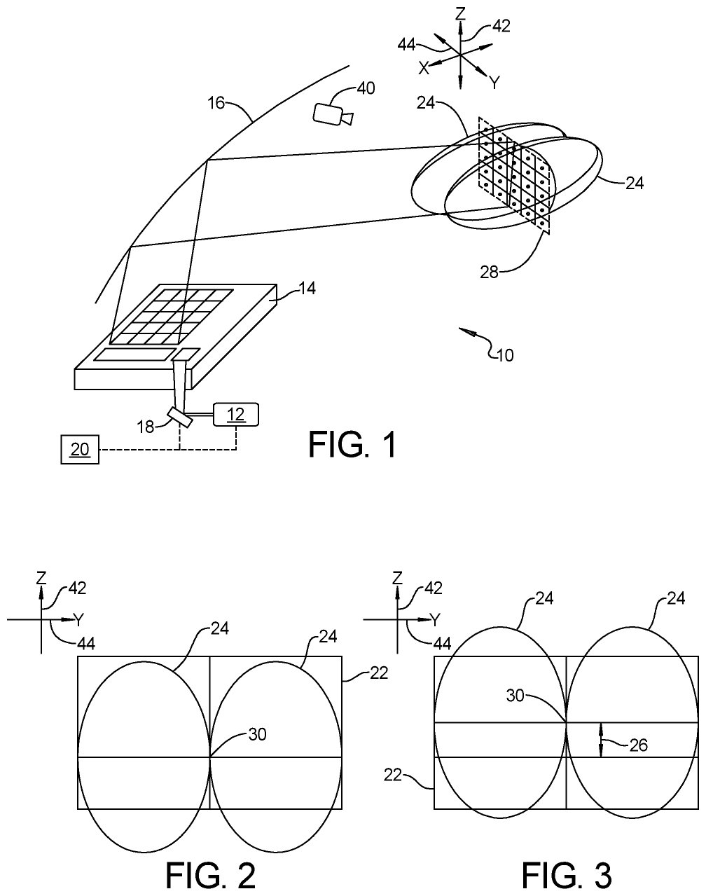

Referring to FIG. 1, a head-up display (HUD) system 10 according to the present disclosure includes a hologram projector 12 that is adapted to project a holographic image.

In an exemplary embodiment, the system 10 includes an exit pupil replicator 14. The holographic image is projected into the exit pupil replicator 14 and then propagates inside the exit pupil replicator 14 and is extracted multiple times before being projected upward to an inner surface of a windshield 16. The re-circulation of the light several times within the exit pupil replicator 14 expands the pupil so the viewer can see the holographic image from an extended eye-box. In addition to expanding the eye-box, the exit pupil replicator 14 also magnifies the original projected image coming out of the hologram projector composed of laser 12, spatial light modulator 18 and controller 20.

A spatial light modulator 18 is positioned between the laser 12 and the exit pupil replicator 14. The spatial light modulator 18 is adapted to receive the light from the laser 12, to diffract the laser light with encoded hologram and to deliver the diffracted laser to the exit pupil replicator 14. A controller 20 is in communication with the laser 12 and the spatial light modulator 18.

The controller 20 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

In an automobile, the controller 20 obtains information of the position of the eyes of a driver of the automobile from a camera of a driver monitoring system within the automobile. The driver monitoring system uses the camera to identify the facial features of the driver and provides information on the vertical location of the eyes of the driver to the controller 20.

The laser 12, spatial light modulator 18, and exit pupil replicator 14 are adapted to project an image upward to the windshield 16 within the automobile. The projected image reflects from an inner surface of the windshield to an eyebox 22. The eyebox 22 is the three-dimensional region within which a driver of the automobile can see the entire projected image from the HUD system. An eyellipse 24 is a three-dimensional graphical depiction of a multivariate normal distribution used to approximate the distribution of driver eye locations within the automobile. The eyellipse 24 is represented by two three-dimensional ellipses, one for the right eye and one for the left eye.

The look down angle (LDA) is the angle at which the eyes of a driver are oriented relative to the virtual image projected to the eyes of the driver. The virtual image distance (VID) is the distance from the driver's eyes the virtual image is perceived by the driver. To accommodate for driver's of different heights, the LDA and the VID are adjustable to ensure the image projected by the hologram projector 12 is perceived at the proper location by all drivers.

In some systems, the controller 20 is adapted to determine the distance that the vertical location of the driver's eyes varies from the pre-determined nominal vertical position. Based on the distance at which the driver's eyes are either higher or lower than the nominal vertical position, the spatial light modulator 18 can adjust the LDA of the holographic image projected by the hologram projector 12. To ensure accurate positioning of the projected image, the system must be calibrated.

Referring to FIG. 2, to ensure a driver of the automobile can properly see the projected image, the eyebox 22 of the projected image must be properly aligned with the eyellipse 24. FIG. 2 is a graphical illustration wherein the eyellipse 24 is properly aligned with the eyebox 22. If there is misalignment between the eyebox 22 and the eyellipse 24, the projected image may not be completely visible to the driver or may appear, to the driver, to be incorrectly positioned. FIG. 3 is a graphical illustration wherein the eyebox 22 for the projected image is low relative to the eyellipse 24. The misalignment is measured by the distance 26 that the eyebox 22 is shifted downward.

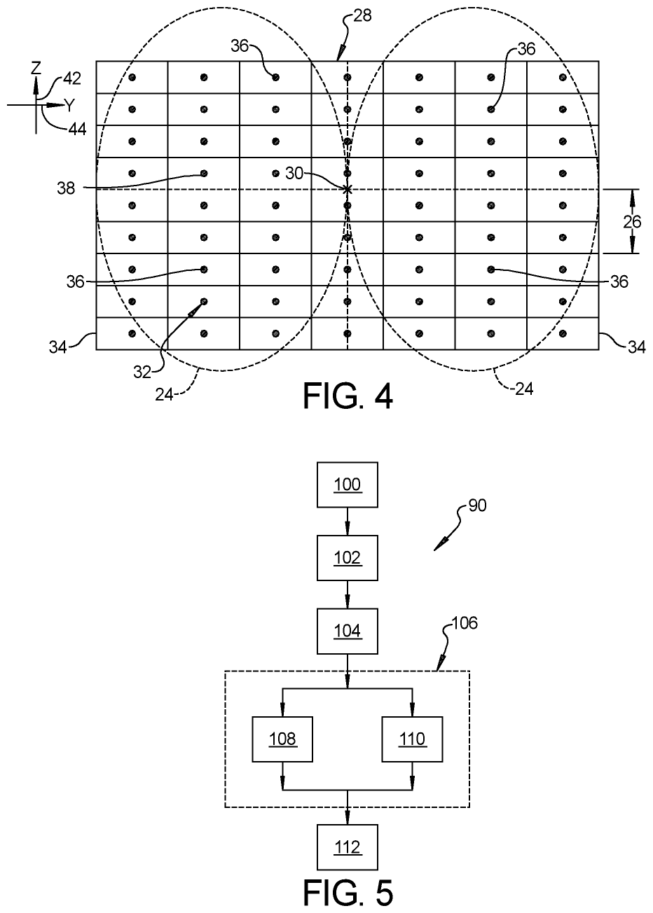

Referring again to FIG. 1, a diffuser 28 is adapted to be positioned within an x-y plane at a center point 30 of the vehicle eyellipse 24. Referring to FIG. 4, the hologram projector 12 is adapted to project a dot pattern 32 onto the diffuser 28. The diffuser 28 may include an outer boundary box 34 to indicate the outline of the eyebox 22. The dot pattern 32 is a two-dimensional array of dots 36. The hologram projector projects the image of the dot pattern 32, and the exit pupil replicator 14 replicates the projected image to a two-dimensional dot array with planar wavefront at the same plane as the diffuser 28 and the center point 30 of the vehicle eyellipse 24. The controller 20 is adapted to compare the location of the projected dot pattern 32 to the center point 30 of the vehicle eyellipse 24 to identify misalignment of the projected dot pattern 32 relative to the center point 30 of the vehicle eyellipse 24.

In an exemplary embodiment, the diffuser 28 includes at least one fiducial pattern 38 that is aligned with the center point 30 of the vehicle eyellipse 24. The at least one fiducial pattern 38 is intended to indicate the position of the projected dot pattern 32. As shown in FIG. 4, the at least one fiducial pattern 38 comprises a grid that provides an indication of the unit exit pupil location. The system 10 includes a camera 40 in communication with the controller 20. The camera 40 may be a camera from a driver monitoring system, and is adapted to identify a position of the at least one fiducial pattern 38 of the diffuser 28 relative to the center point 30 of the vehicle eyellipse 24 to allow the system 10 to align the at least one fiducial pattern 38, and the diffuser 28, with the center point 30 of the vehicle eyellipse 24 when positioning the diffuser 28.

In another exemplary embodiment, the camera 40 is further adapted to identify a position of the projected dot pattern 32 relative to the at least one fiducial pattern 38 to allow the controller 20 to compare the location of the projected dot pattern 32 to the center point 30 of the vehicle eyellipse 24 and identify misalignment of the projected dot pattern 32 relative to the center point 30 of the vehicle eyellipse 24. Misalignment may also be identified by an individual by visual inspection of the location of the projected dot pattern 32 relative to the center point 30 of the vehicle eyellipse 24, as indicated by the at least one fiducial pattern 38 on the diffuser 28. As shown in FIG. 4, just as in FIG. 3, the eyebox 22 for the projected image is low relative to the vehicle eyellipse 24. In this example, the misalignment is along the Z-axis 42, however, the controller 20 is adapted to compare the location of the projected dot pattern 32 to the center point 30 of the vehicle eyellipse 24 to identify both horizontal misalignment along the y-axis 44 and vertical misalignment along the z-axis 42.

Once misalignment has been identified, the controller 20 is further adapted to adjust the projected dot pattern 32 to align the projected dot pattern 32 with the at least one fiducial pattern 38 and the vehicle eyellipse 24 by fine-tuning a laser incident angle from the spatial light modulator 18 to the exit pupil expander 14 of the head up display system 10 to align the projected dot pattern 32, and thus the eyebox 22, with the at least one fiducial pattern 38 and the vehicle eyellipse 24. By adjusting the laser incident angle of the projected image from the spatial light modulator 18, the projected dot pattern 32 may be moved up or down or side to side relative to the diffuser 28, and thus, the vehicle eyellipse 24.

In one exemplary embodiment, the controller 20 is adapted to automatically adjust the projected dot pattern 32 once misalignment of the projected dot pattern 32 is identified with the camera 40, providing automatic calibration of the system 10. In another exemplary embodiment, the controller 20 is adapted to allow manual adjustment of the projected dot pattern 32 once misalignment of the projected dot pattern 32 is identified visually. This would allow an individual to manually fine-tune the system 10 to specific calibration specifications or personal preference.

In another exemplary embodiment, the controller 20 is adapted to compile a model of adjustment parameters for different eyellipse 24 positions. Thus, once a driver is positioned within the vehicle, cameras within the vehicle will identify the position of the vehicle eyellipse 24 for that driver, and apply previously determined calibration adjustments to approximate the proper calibration of the projected image.

Referring to FIG. 5, a method 90 of calibrating a head up display system 10 for an automobile includes, beginning at block 100, placing a diffuser 28 that is aligned with an x-y plane at a center point 30 of a vehicle eyellipse 24. In an exemplary embodiment, the diffuser 28 includes at least one fiducial pattern 38 that is aligned with the center point 30 of the vehicle eyellipse 24, and the diffuser 28 is aligned with the x-y plane at the center point 30 of the vehicle eyellipse 24 by using a camera 40 to align the at least one fiducial pattern 38 with the center point 30 of the vehicle eyellipse 24 when placing the diffuser 28. In another exemplary embodiment, the camera 40 is a camera of a driver monitoring system.

Moving to block 102, the method 90 includes projecting, with the hologram projector 12 of the head up display system 10, a dot pattern 32 onto the diffuser 28, and moving to block 104, comparing the location of the projected dot pattern 32 to the center point 30 of the vehicle eyellipse 24 to identify misalignment of the projected dot pattern 32 relative to the center point 30 of the vehicle eyellipse 24. In an exemplary embodiment, the method 90 includes using the camera 40 to compare the location of the projected dot pattern 32 to the at least one fiducial pattern 38 to identify misalignment of the projected dot pattern 32 relative to the center point 30 of the vehicle eyellipse 24. Misalignment may include horizontal misalignment along the y-axis 44 and vertical misalignment along the z-axis 42.

Moving to block 106, the method 90 includes adjusting the projected dot pattern 32 to align the projected dot pattern 32 with the at least one fiducial pattern 38 and the vehicle eyellipse 24. In one exemplary embodiment, the adjusting the projected dot pattern 32 further includes fine-tuning a laser incident angle from a spatial light modulator 18 to an exit pupil expander 14 of the head up display system 10 to align the projected dot pattern 32 with the at least one fiducial pattern 38 and the vehicle eyellipse 24.

Moving to block 108, in one exemplary embodiment, the head up system 10 further includes a controller 20 in communication with the camera 40 and the controller 20 is adapted to control the spatial light modulator 18 and the exit pupil expander 14, wherein the adjustment of the projected dot pattern 32 is done automatically once misalignment of the projected dot pattern 32 is identified with the camera 40 and controller 20. Alternatively, moving to block 110, in another exemplary embodiment, the adjustment of the projected dot pattern 32 is done manually once misalignment of the projected dot pattern 32 is identified visually.

Moving to block 112, in still another exemplary embodiment, the method 90 further includes creating a model of adjustment parameters for different eyellipse positions. The controller 20 stores adjustment parameters each time the system 10 is calibrated to create a table of adjustment parameters that can be used.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of calibrating a head up display system for an automobile, comprising:
placing a diffuser that is aligned with an x-y plane at a center point of a vehicle eyellipse;
projecting, with the head up display system, a dot pattern onto the diffuser; and
comparing the location of the projected dot pattern to the center point of the vehicle eyellipse to identify misalignment of the projected dot pattern relative to the center point of the vehicle eyellipse.

2. The method of claim 1, wherein the diffuser includes at least one fiducial pattern that is aligned with the center point of the vehicle eyellipse.

3. The method of claim 2, further including using a camera to align the at least one fiducial pattern with the center point of the vehicle eyellipse when placing the diffuser.

4. The method of claim 3, further including using the camera to compare the location of the projected dot pattern to the at least one fiducial pattern to identify misalignment of the projected dot pattern relative to the center point of the vehicle eyellipse.

5. The method of claim 4, wherein the camera is a camera of a driver monitoring system.

6. The method of claim 4, further including identifying horizontal misalignment along a y-axis and identifying vertical misalignment along a z-axis.

7. The method of claim 6, further including adjusting the projected dot pattern to align the projected dot pattern with the at least one fiducial pattern and the vehicle eyellipse.

8. The method of claim 7, wherein, the adjusting the projected dot pattern further includes fine-tuning a laser incident angle from a spatial light modulator to a pupil expander of the head up display system to align the projected dot pattern with the at least one fiducial pattern and the vehicle eyellipse.

9. The method of claim 8, wherein the head up system further includes a controller in communication with the camera and adapted to control the spatial light modulator and pupil expander, and the adjustment of the projected dot pattern is done automatically once misalignment of the projected dot pattern is identified with the camera.

10. The method of claim 8, wherein the adjustment of the projected dot pattern is done manually once misalignment of the projected dot pattern is identified visually.

11. The method of claim 8, further including creating a model of adjustment parameters for different eyellipse positions.

12. A head-up display system, comprising:
a hologram projector adapted to project a holographic image;
at least one spatial light modulator;
an exit pupil replicator;
a diffuser adapted to be positioned within a x-y plane at a center point of a vehicle eyellipse, the hologram projector adapted to project a dot pattern onto the diffuser; and
a controller adapted to compare the location of the projected dot pattern to the center point of the vehicle eyellipse to identify misalignment of the projected dot pattern relative to the center point of the vehicle eyellipse.

13. The system of claim 12, wherein the diffuser includes at least one fiducial pattern that is aligned with the center point of the vehicle eyellipse.

14. The system of claim 13, further including a camera in communication with the controller and adapted to identify a position of the at least one fiducial pattern relative to the center point of the vehicle eyellipse to allow the system to align the at least one fiducial pattern with the center point of the vehicle eyellipse when positioning the diffuser.

15. The system of claim 14, wherein the camera is further adapted to identify a position of the projected dot pattern relative to the at least one fiducial pattern to allow the controller to compare the location of the projected dot pattern to the center point of the vehicle eyellipse and identify misalignment of the projected dot pattern relative to the center point of the vehicle eyellipse.

16. The system of claim 15, wherein the controller is adapted to compare the location of the projected dot pattern to the center point of the vehicle eyellipse to identify horizontal misalignment along a y-axis and vertical misalignment along a z-axis.

17. The system of claim 16, wherein the controller is further adapted to adjust the projected dot pattern to align the projected dot pattern with the at least one fiducial pattern and the vehicle eyellipse.

18. The system of claim 17, wherein the controller is adapted to fine-tune a laser incident angle from the spatial light modulator to the pupil expander of the head up display system to align the projected dot pattern with the at least one fiducial pattern and the vehicle eyellipse.

19. The system of claim 18, wherein the controller is adapted to one of:
automatically adjust the projected dot pattern once misalignment of the projected dot pattern is identified with the camera; and
allow manual adjustment of the projected dot pattern once misalignment of the projected dot pattern is identified visually.

20. The system of claim 19, wherein the controller is adapted to compile a model of adjustment parameters for different eyellipse positions.
